(19) United States
(12) Patent Application Publication
(10) Pub. No.: US 2018/0020476 A1
(43) Pub. Date: Jan. 18, 2018

(54) APPARATUS AND METHOD FOR SIMULTANEOUS TRANSMIT AND RECEIVE NETWORK MODE

(71) Applicant: Kabushiki Kaisha Toshiba, Minato-ku (JP)

(72) Inventors: Adnan AIJAZ, Bristol (GB); Zhenzhe ZHONG, Bristol (GB); Fengming CAO, Bristol (GB); Parag Gopal KULKARNI, Bristol (GB); Russell John HAINES, Bristol (GB)

(73) Assignee: Kabushiki Kaisha Toshiba, Minato-ku (JP)

(21) Appl. No.: 15/442,976

(22) Filed: Feb. 27, 2017

(30) Foreign Application Priority Data
Jul. 15, 2016 (GB) 1612342.4

(51) Int. Cl. H04W 74/04; H04L 5/00; H04L 29/06; H04W 84/12

(52) U.S. Cl. CPC H04W 74/04; H04L 69/28; H04L 5/0055; H04W 84/12

(57) ABSTRACT

A device and method of scheduling data transmission in a communication system comprising receiving at a first network node a request for data transmission to the first network node and scheduling a data transmission originating at first network node so that the end of the data transmission substantially coincides with or is earlier than the expected end of the data transmission to first network node. The first network node is an access point or a station.

### FIELD

Embodiments described herein relate generally to apparatus and methods for simultaneous transmit and receive in networks and preferably to simultaneous transmit and receive in IEEE 802.11 networks in full-duplex/half-duplex co-existence scenarios.

### BACKGROUND

Due to recent advances in analogue and digital self-interference cancellation techniques, full-duplex (FD) radios, that can simultaneously transmit and receive, can be practically realised. The FD transceiver differs from its half-duplex (HD) counterpart in that, it uses self-interference cancellation methods to eliminate the interference from the signal it sends, so as to be able to successfully receive simultaneously. The self-interference cancellation technique, however, cannot mitigate interference from other RF sources.

In the following, embodiments will be described with reference to the drawings in which:

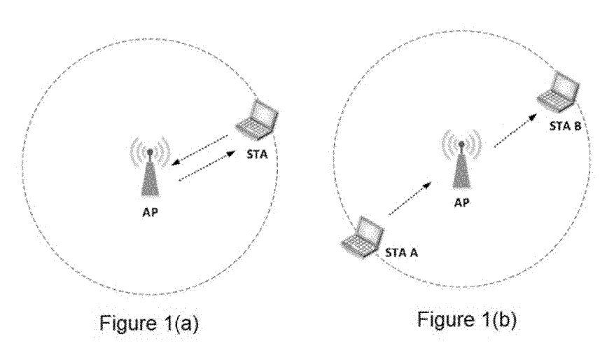

FIG. 1(a) shows FD capable IEEE 802.11 access point (AP) and station (STA) operating in FD data exchange;

FIG. 1(b) shows an FD capable access point operating in UFD mode, transmitting and receiving data to/from FD or HD capable stations;

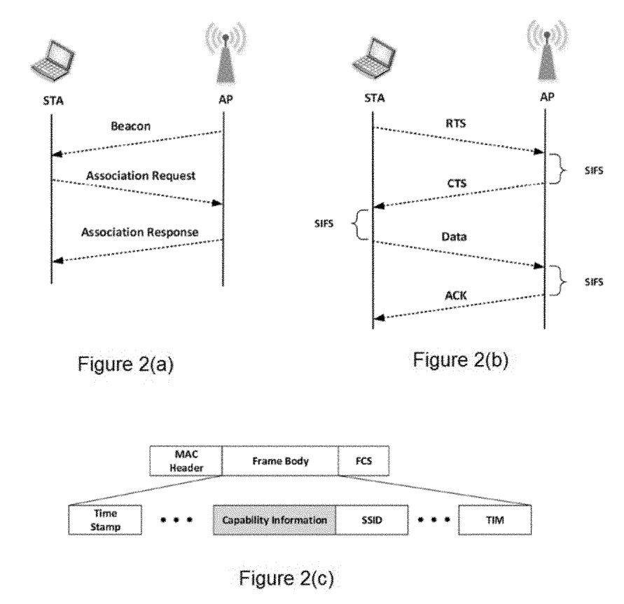

FIG. 2(a) illustrates an exchange in legacy 802.11 networks with signals association with the AP;

FIG. 2(b) illustrates an exchange in legacy 802.11 networks with the RTS/CTS control message exchange for data transmission;

FIG. 2(c) illustrates a capability information field within the general 802.11 management frame;

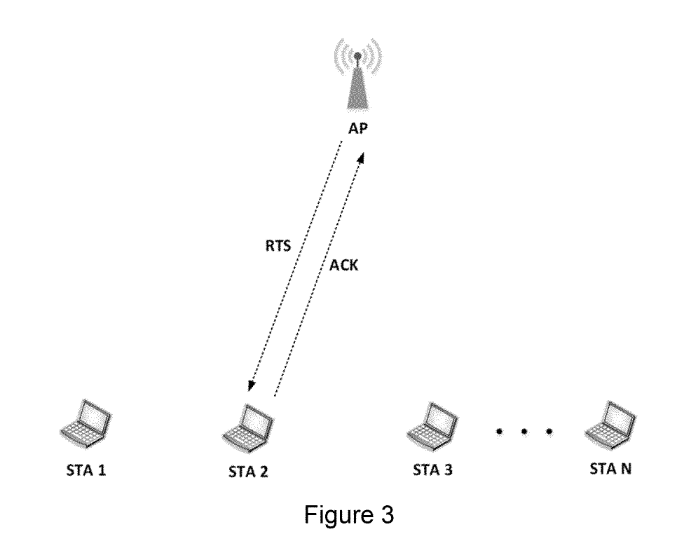

FIG. 3 shows a network initialization phase. Neighbouring STAs overhear the ACK and maintain a neighbourhood information table;

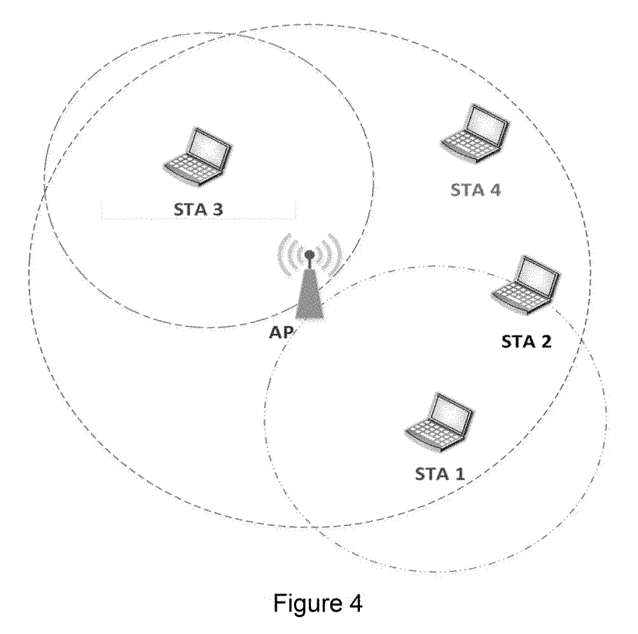

FIG. 4 shows a system model for a proposed solution according to an embodiment. Dotted lines show interference ranges. Each of the STAs could be HD or FD capable;

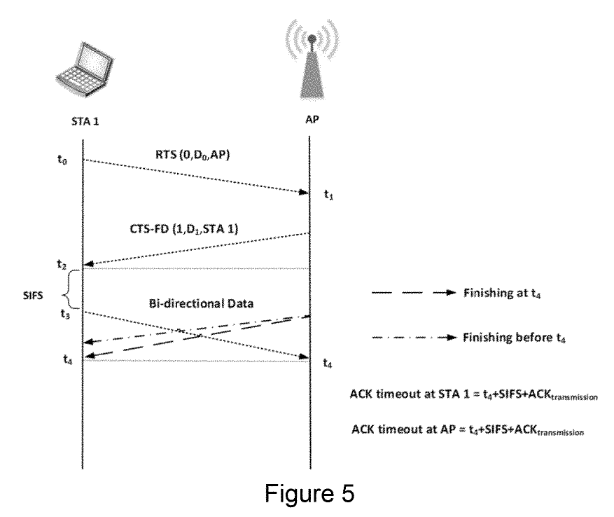

FIG. 5 shows an RTS/CTS-FD control message exchange for data transmission in BFD transmission. The adaptive ACK timeout setting mechanism is also illustrated;

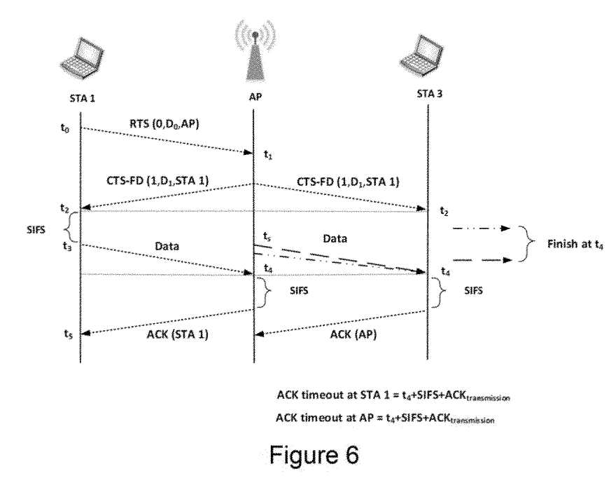

FIG. 6 shows RTS/CTS-FD control message exchange for data transmission in UFD transmission. The adaptive ACK timeout setting mechanism is also illustrated;

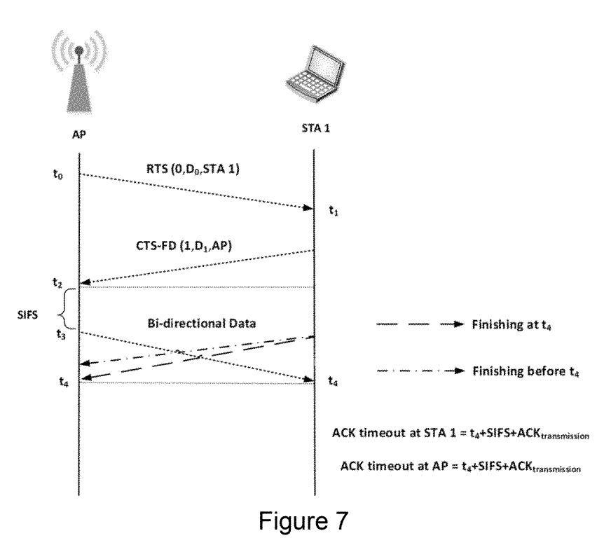

FIG. 7 illustrates RTS/CTS-FD control message exchange for data transmission in an AP-initiated BFD transmission. The adaptive ACK timeout setting mechanism is also illustrated;

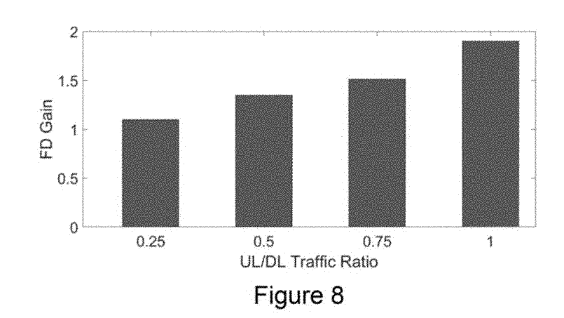

FIG. 8 shows simulation results for achievable gain of the enabling STR mode in 802.11 networks;

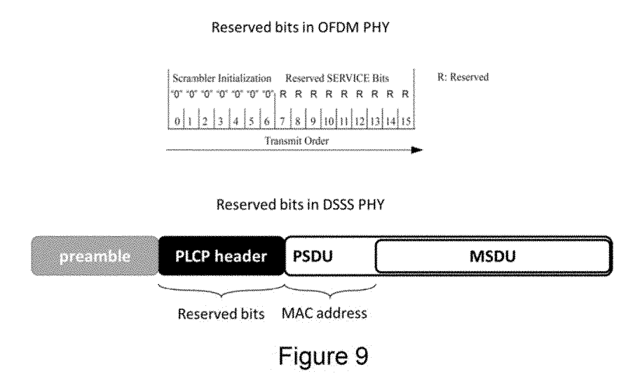

FIG. 9 shows examples of existing reserved bits in DSSS PHY;

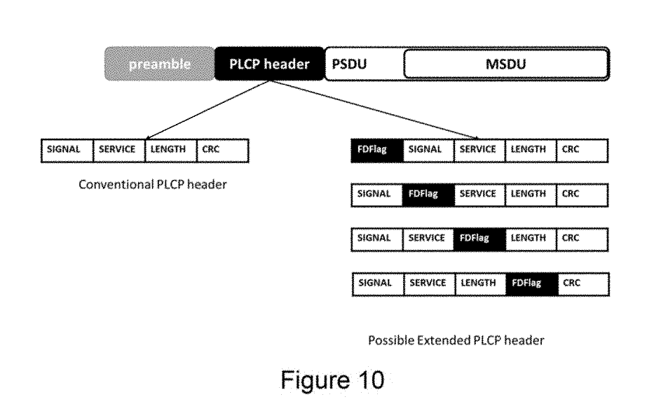

FIG. 10 shows possible forms of extended PLCP headers;

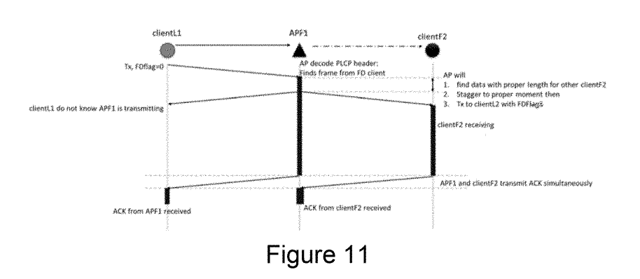

FIG. 11 illustrates an embodiment in which UFD transmission initiated by a legacy STA is implemented by setting FDFlag0 and FDFlag3 in the primary and secondary transmission case respectively;

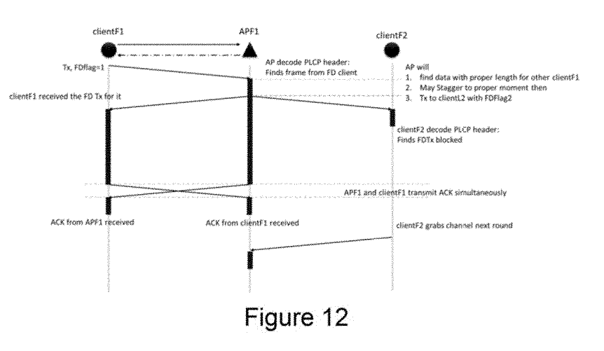

FIG. 12 illustrates an embodiment in which BFD transmission initiated by a FD STA is realised by setting FDFlag1 and FDFlag2 in the primary and secondary transmission case respectively;

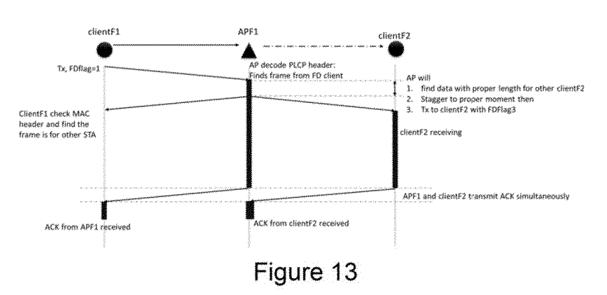

FIG. 13 illustrates an embodiment in which UFD transmission initiated by a FD STA is implemented by setting FDFlag1 and FDFlag3 in the primary and secondary transmission case respectively;

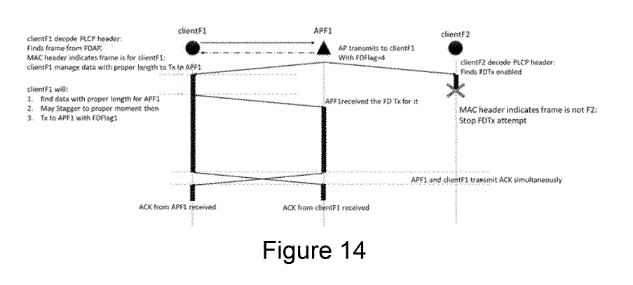

FIG. 14 illustrates an embodiment in which BFD transmission initiated by the AP can be realised by setting FDFlag4 and FDFlag1 in the primary and secondary transmission case respectively;

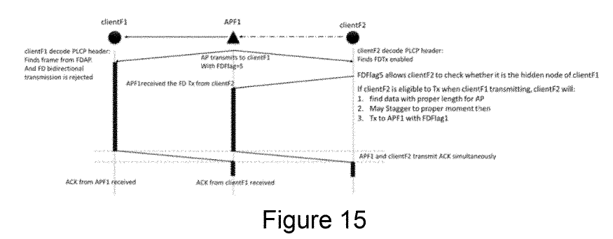

FIG. 15 illustrates an embodiment in which UFD transmission initiated by the AP are realised by setting FDFlag5 and FDFlag1 in the primary and secondary transmission case respectively;

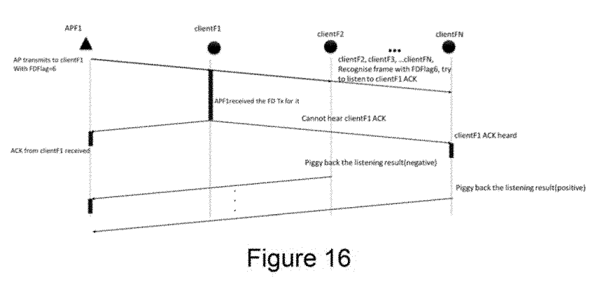

FIG. 16 shows a process in which the FDFlag6 flag is used for identifying statistic hidden nodes in a network;

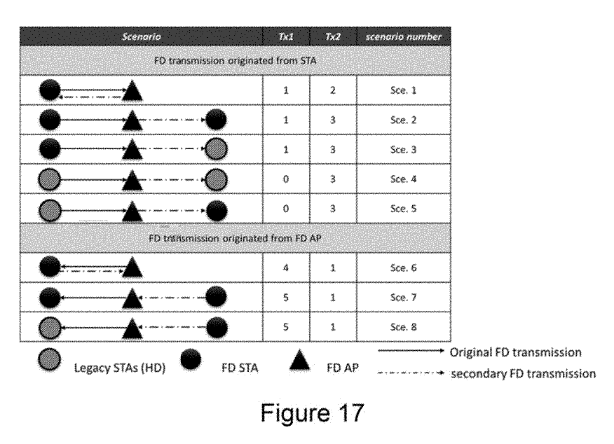

FIG. 17 summarises the possible scenarios of using flags to achieve both unidirectional and bidirectional FD;

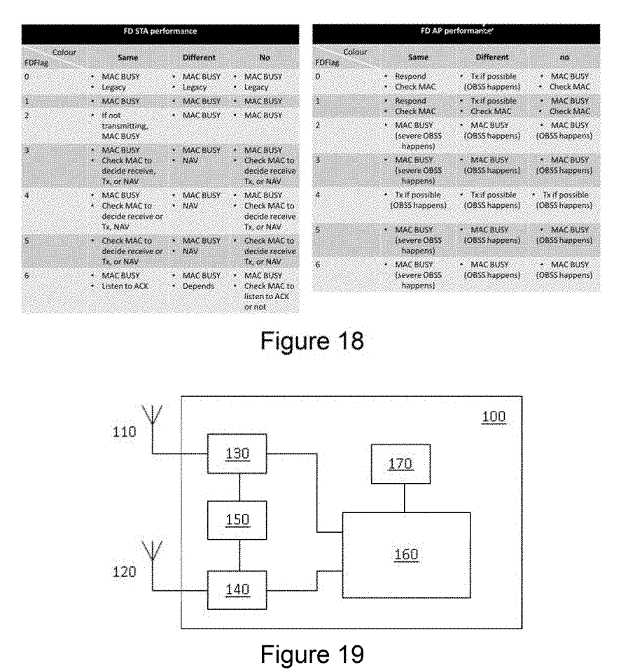

FIG. 18 shows logic of STA/AP dealing with FDFlags in different colouring scenario;

FIG. 19 shows the architecture of an FD AP according to an embodiment;

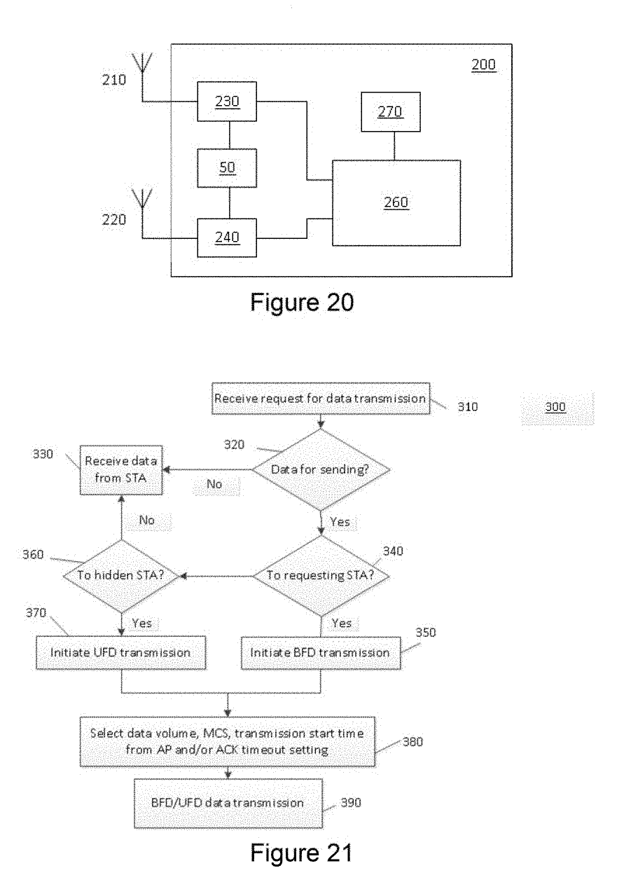

FIG. 20 shows the architecture of an FD STA according to an embodiment; and

FIG. 21 shows a method performed in an AP.

### DETAILED DESCRIPTION

According to an embodiment there is provided a method of scheduling data transmission in a communication system. The method comprises receiving at a first network node a request for data transmission to the first network node and scheduling a data transmission originating at first network node so that the end of the data transmission substantially coincides with or is earlier than the expected end of the data transmission to first network node. The first network node is an access point or a station.

In an embodiment the data associated with the requested transmission is received and the data scheduled for transmission is transmitted from the first network node.

The received request may comprise an indication of the time required for completing the requested data transmission.

A data size or MCS or a delay to the start of the data transmission originating from the first network node may be chosen by the first network node so that the ends of the two data transmissions substantially coincide or so that the scheduled data transmission finishes before the data transmission requested to be transmitted to the first network node.

An acknowledgement may be received at the first network node after the end of the data transmissions and an acknowledgement may be transmitted from the first network node after the end of the data transmission.

If the first network node is an access point and the request for a data transmission to the first network node originated at a first STA the scheduled data transmission may be for the first SAT or for a second, different STA.

The second, different STA may be hidden from the first STA.

If the first network node is not an AP, that is if the data exchange has been initiated by and STA, the AP may decide whether BFD or UFD transmission or a simple receipt of data from the requesting STA is to take place.

The control of data transmission can be done dynamically on a frame by frame basis, depending only on the data transmission needs at a given moment.

The method may further comprise determining the end of an acknowledgement timeout period for the data transmitted from the AP on the basis of the expected duration of the data received or to be received at the AP.

Scheduling a data transmission may further comprise determining whether or not a request for data for transmission to another network node has been generated or received at the first network node.

Scheduling a data transmission may comprise scheduling a data transmission to a network node other than the network node from which the request for data transmission has been received. The other network node may be selected on the basis of neighbourhood information available to the first network node so that the selected network node and the network node from which the request for data transmission has been received are partially or fully hidden from each other.

The method may further comprise transmitting data according to the scheduled data transmission and transmitting an indicator identifying that the data transmission is a BFD or UFD data transmission. This puts nodes not participating in the data transmission on notice to allow them to remain quiescent during the data exchange.

According to another embodiment there is provided a method of capability discovery in a wireless network comprising FD capable nodes within the network advertising FD capability to other nodes by setting a flag or capability bit indicative of FD capability in a beacon. RTS control message, PLCP and/or MAC header.

The flag or capability bit may be set in a part of the beacon, RTS control message, PLCP and/or MAC header that is not accessed by network nodes that are not FD capable. This ensures backward compatibility

BFD/UFD data transmissions may be scheduled by an access point on the basis of discovered FD abilities of nodes in the network. The AP may comprise a memory in which data identifying discovered FD abilities are stored.

If the PLCP header is used for the transmission of the flag or capability bit no central control or extra RTS/CTS messages are needed. Reserved bits used in the header may represent the status of the frame and of the node.

The indicator may indicate that the transmission from the first network node is a secondary transmission from a FD AP in a BFD transmission, a secondary transmission from a FD AP in a UFD transmission, a primary transmission originating from a FD AP in a potential FD communication or that the AP wants to initiate a hidden node information collection procedure.

According to another embodiment there is provided a device configured to execute computer program instructions, the computer program instruction such as to configure the device to schedule data transmission in a communication system comprising a FD access point and one or more STAs by receiving at the device a request for data transmission to the device and scheduling a data transmission originating the device so that the end of the data transmission substantially coincides with or is earlier than the expected end of the data transmission to device. Wherein the device is the access point or an STA of the one or more STAs.

According to another embodiment there is provided a FD capable AP configured to discover node capability in a wireless network comprising FD capable nodes by advertising FD capability to other nodes by setting a flag or capability bit indicative of FD capability in a beacon, RTS control message, PLCP and/or MAC header.

According to another embodiment there is provided a FD capable AP configured to support BFD or UFD transmission in a network comprising FD and HD network nodes, the AP configured to generate different headers for indicating type and target of the transmission to the nodes in the network depending on whether the header is to be used in communication with a HD or FD node.

According to another embodiment there is provided a system comprising an FD AP and HD and/or FD capable nodes, wherein the FD AP and/or one or more of the FD capable nodes is a device as described above or wherein the FD AP is a FD AP as described above.

According to another embodiment there is provided a computer program product storing computer executable code configured to, when executed by a processor, cause a device comprising the processor to implement any of the methods described above.

Conventionally, wireless networks have been built on half-duplex (HD) radios which cannot transmit and receive simultaneously due to self-interference, that is interference generated by the transmitted signal on the received signal. Due to recent advances in self-Interference cancellation, full-duplex (FD) radios, that can simultaneously transmit and receive, can be practically realised. To realise simultaneous transmit and receive (STR) mode in IEEE 802.11 networks, two distinct types of wireless links can be created: a) Bi-directional Full-Duplex (BFD) link in which a pair of FD-capable access point (AP) and station (STA) can simultaneously transmit/receive to/from each other, (b) Uni-directional Full-Duplex (UFD) in which the AP can simultaneously transmit to a Full-Duplex/Half-Duplex (HD) STA (i.e. a STA that cannot transmit and receive simultaneously) while receiving from another FD/HD STA. Both these types of links are illustrated in FIGS. 1(a) and 1(b) respectively.

Enabling STR mode in 802.11 networks creates a number of challenges. FD nodes (APs and STAs) should be able to co-exist with the legacy HD nodes with minimal protocol modifications. FD APs and STAs should be able to discover the FD capabilities while co-existing with the legacy HD nodes. Further, BFD and UFD transmissions should be enabled without modifications to the legacy channel access mechanisms. The unique characteristics of UFD transmission enable two HD nodes to simultaneously transmit/receive to/from the AP. However, not all the nodes within the coverage of the AP can be part of the UFD transmission as nodes that are not hidden from each other are likely to interfere. The proposed invention facilitates coexistence of FD and HD STAs associated to an FD or a legacy (HO) access point.

In legacy 802.11 networks (HD communications), nodes expect an acknowledgement (ACK) after sending a data packet. However, in case of BFD transmission, since the data packets are sent by both nodes simultaneously, it is possible that a node is still busy sending data packages after successful receipt of an incoming data package and cannot consequently send an acknowledgement in a timely fashion. This can lead to ACK timeout. This issue can become particularly challenging for UFD transmission.

FIGS. 2(a)-2(c) depict the signalling exchange in legacy 802.11 wireless networks. To allow STAs to associate with an AP the AP broadcasts the beacon frame at periodic intervals, as illustrated in FIG. 2(a). The beacon frame contains information related to the network. A STA associates with the AP by sending an association request frame. The AP responds by sending an association response message. For initiating a data transmission, the STA first sends a request to send (RTS) message as illustrated in FIG. 2(b). If RTS message transmission is successful, the AP responds with a clear to send (CTS) message after waiting for a short interframe space (SIFS) duration. The sender node, on receiving a CTS message, waits for the SIFS duration and transmits the data message. The AP transmits an ACK a SIFS duration after it receives the data message. If the STA does not receive an ACK during the ACK timeout period (which is set when sending the data message), it re-transmits the data message.

Embodiments enable the co-existence of FD and HD STAs, and therefore has some key structural differences from the legacy approach, which are described as follows.
a) FD capability discovery—In practice, FD nodes will be co-existing with the legacy HD nodes. To support this, in embodiments FD capable nodes (APs and STAs) are able to discover FD capabilities in an autonomous manner. The embodiments achieve this without need to modify the frame structure. Instead additional information is overloaded in existing fields without affecting backward compatibility.
b) Eligible node identification phase—In case of UFD transmission (illustrated in FIG. 1), the two nodes simultaneously served by the AP must be out of the interference range of each other. This is particularly important to ensure that the first transmitter (STA A transmitting to the AP) should not interfere with the receiver (STA B receiving from the AP) of second transmitter (AP). Therefore, the AP must know which nodes are eligible to become part of the UFD transmission. Embodiments achieve this through a simple procedure, based on neighbourhood information, during the network initialization phase.
c) CTS-FD control message—In order to initiate BFD and UFD transmissions, one embodiment use the legacy CTS control message with 1-bit modification in any ‘reserved’ bit. This modification is completely backward compatible.
d) Adaptive ACK timeout setting—In legacy HD 802.11 networks nodes expect an ACK after sending a data packet. However, in case of BFD transmission, since the data packets are sent by both nodes simultaneously, each node gets data packets before getting an ACK, which leads to ACK timeout. The issue of ACK timeout becomes particularly challenging in case of UFD transmission since a FD node (AP in this case) cannot simultaneously transmit OR receive to/from two different nodes. The embodiments utilize a simple and novel approach for ACK timeout setting at the nodes engaged in BFD and UFD transmission. Nodes engaged in HD transmission set the ACK timeout in the legacy way; hence, the embodiments are completely backward compatible.

In some but not in all embodiments any FD communication must be preceded by an RTS from the initiating node. Moreover, any FD/HD STA is capable of receiving when the NAV is set.

The following embodiments are described in the context of a single-cell multi-user 802.11 network scenario in which both FD and HD STAs co-exist. Initially, nodes in the network are able to discover the FD capabilities. To facilitate this in the embodiment the AP periodically advertise its FD capability in the beacon frame. STAs in the network learn from the beacon transmission if the AP is FD capable or not. In an embodiment the FD capability of the AP is advertised within the ‘capability information’ field (illustrated in FIG. 2(c)) of the beacon frame. The capability information field comprises 2 bytes, out of which 1 byte is reserved. The FD capability can be advertised through a 1 bit change in any of the reserved bits. This could also be achieved by advertisement through the BSSID field or other empty fields in the beacon.

In an embodiment a FD STA in the network informs the AP of its FD capabilities when sending the association request frame. In the embodiment the FD capability is advertised through a 1 bit change in any of the reserved bits of the 2 byte capability information field within the association request frame.

STA-Initiated Communication Scenario

After discovering the FD capabilities, any FD capable node can engage in a BFD or UFD transmission with the AP. However, not all the STAs in the network can potentially become part of a UFD transmission. In the embodiment it is preferred that the two STAs simultaneously served by the AP are substantially out of the interference range of each other.

In one embodiment the AP learns which nodes are eligible to become part of the UFD transmission through a simple procedure during the network initialization phase. In this procedure neighbourhood information is exchanged between STAs and APs. During the network initialization phase, the AP sends a message (e.g. a RTS) to each STA in turn as shown in FIG. 3. The respective STA (STA 2 in this case) responds back with an ACK. Other STAs overhear the ACK and maintain a neighbourhood information table. For example, STAs lying within the interference range of STA 2 overhear the ACK and add ID of STA 2 in the neighbourhood information table. At the end of the network initialization phase, each STA reports its neighbourhood table to the AP. Based on the overall neighbourhood information, the AP learns which STAs are eligible to become part of the UFD transmission.

Nodes will at some point engage in an RTS-CTS exchange with the AP in those embodiments that use RTS-CTS messages. In an alternative method all other nodes that can hear a CTS but not an RTS record the destination address in the CTS message and store this. Using the bitmap which the AP maintains and makes available to all STAs in the cell e.g. via beacons or some other messages, the STAs stores the bitmap corresponding to the stored destination id. This enables each STA to report the hidden STA bitmap via a dedicated signalling/data frame or by piggybacking this information on existing messages that it sends to the AP. Once the AP receives this information, it has a list of hidden STAs corresponding to each STA in the cell.

In a yet further method each STA can overhear transmissions on the medium and record the source Id of each such Tx that it can decode. The STA stores the bitmap corresponding to all of the STAs that it can hear and report this to the AP in a similar manner as that described in the preceding paragraph. The AP can then identify a list of hidden STAs of this STA by identifying the ones from its associated STAs list that do not overlap with the list reported by the STA.

In the following the procedure for legacy HD, BFD, and UFD transmissions in case of FD/HD co-existence scenario is detailed. Reference is made to the scenario illustrated in FIG. 4 and it is assumed that STA 1 has data to send to the AP. Several feature combinations are possible:

Case 1: Both STA 1 and AP are HD capable. In this case the legacy procedure (shown in FIG. 1) is followed. STA 1 transmits an RTS message and the AP responds with a CTS message, after which data transmission can start.

Case 2: STA 1 is FD capable and AP is HD capable. The legacy procedure is followed in this case as well, as the AP cannot engage in FD data exchange.

Case 3: STA 1 is HD capable and AP is FD capable. In this case there are two possibilities: (i) STA1 and AP engage in a HD transmission using the legacy procedure, and (ii) the AP establishes a UFD transmission with STA 1 and another (eligible) STA.

Case 4: Both STA 1 and AP are FD capable. In this case, there are three possibilities: (i) Both STA 1 and AP can engage in a BFD transmission, (ii) a UFD transmission involving STA 1 and AP an another eligible STA, or (iii) STA 1 and AP can engage in the legacy HD transmission (this can happen if AP does not have data to send to STA1 or other STAs to which AP could transmit whilst receiving data from STA1).

In the following some of the fields in RTS and CTS control messages are discussed. The RTS and CTS (and ACK) messages contain a ‘Duration ID’ field (henceforth referred to as the ‘duration’ field). This field specifies the total transmission time required for the frame that is to be sent. The STAs receiving RTS read the duration field and set their NAV, which is an indicator for the STA on how long it must defer from accessing the medium. For example, the duration field in the RTS message is set to the time needed to transmit data, CTS, and ACK messages with explicitly accounting for the SIFS duration.

The CTS-FD control message employed in a preferred embodiment differs from the legacy control message by 1 bit i.e., any reserved bit in the Frame Control (FC) field, which precedes the duration field, of CTS-FD message is set to 1. Legacy FC field contains two distinct fields: a 2-bit ‘Type’ field and a 4-bit ‘Sub-type’ field. Currently, Type values of ‘00’, ‘01’, and ‘10’ indicate management, control, and data frames, respectively. However, Type value of ‘11’ is reserved. Further, 9 Sub-type values from 0000 to 1001 for the control frame (Type value of 01) are reserved. Therefore, the CTS-FD control message is completely backward compatible with legacy HD STAs and its practical realization is not a challenge.

BFD Transmission

Consider that at time to STA 1 sends a RTS message to the AP as shown in FIG. 5. The three fields associated with the RTS message in FIG. 5 correspond to the reserved bit of the FC field, duration field, and the destination address, respectively. The RTS message reaches AP at time t₁. It will be noted that there is no need for the RTS message to include a change in a reserved bit in the FC field as, at the time STA1 initiates data transfer to AP sends the RTS message it is not known if there is a desire by the AP for FD data transmission. Up to this point STA1 consequently behaves as if HD data transfer is desired.

If the AP has data to send to STA 1, it responds with a CTS-FD message after waiting for SIFS duration. The CTS-FD sent by the AP has the reserved bit of FC field set to 1 to indicate that a FD exchange is started and differs in this respect from a legacy CTS message. The CTS-FD message also includes the destination address of STA 1 to indicate that the FD exchange is a BFD exchange with STA1. The CTS-FD therefore informs STA 1 of a possible BFD transmission.

After waiting for a SIFS duration, STA 1 starts data transmission (at time point t₃). Similarly, after sending the CTS-FD message, the AP waits for SIFS duration and sends a data message (with the destination address of STA 1). Therefore, a BFD transmission occurs between STA 1 and the AP. The ACK procedure will be described later. As discussed later, the data transmission from AP to STA 1 needs to end before or at time t₄. Time t₄ is known to the AP as the RTS message includes information (in the form of duration D₀) regarding the time the data transmission requested by STA1 is expected to take. D₀ covers the entire time span from t₁ to t₅, so that D0=3*SIFS+T_CTS+T_Data+T_Ack, T_Data is the time period between t₃ and t₄ and T_ACK is the time between t₄+SIFS and t₅. t₄ can therefore be calculated as t₄=D₀−(SIFS+T_Ack).

As can be seen from FIG. 5, it is possible that the data transmission from the AP to STA1 is completed before time t₄. This is not problematic as it is the AP that has decided to instigate FD transmission and knows when the data transmission from STA1 is completed. As a consequence the AP knows when it can expect the ACK from STA1 and is configured to re-calculate the time point by which an acknowledgement from STA1 can be expected and will consequently not trigger an ACK timeout earlier than this time point.

Given that STA1 may expect an ACK from the AP shortly after t₄, the AP proceeds by selecting one or more of the payload, the MCS (modulation and coding scheme) and the time at which the data transmission is started to ensure that its data transmission to STA1 is completed before or at t₄. Once both data transmissions have been completed at time t₄ STA1 and the AP are both free to send ACK messages and, in doing so, avoid an ACK time out that, by the legacy protocol is set to occur at time point t₄+SIFS+ACKₜᵣₐₙₛₘᵢₛₛᵢₒₙ.

UFD Transmission

At time to STA1 sends an RTS message to the AP, as shown in FIG. 6. The format of the RTS sent from STA1 to AP is the same as that discussed above with reference to FIG. 5. In this scenario, however, the AP has data to send to STA3 and STA2 but not to STA1. Therefore, the AP can potentially establish a UFD transmission. Since STA 2 is, as shown in FIG. 4, within the interference range of STA1, the AP realises that it is not optimal or even possible to send data to STA2 whilst receiving data from STA1 in an UFD transmission. It is recalled that the AP learns which nodes are eligible to take part in the UFD transmission during the network initialization phase. Thus, the AP responds to the RTS by transmitting a CTS-FD message with the destination address of STA 1 and a duration field set to ‘D₁’. The STAs receiving the CTS-FD message do not know if a BFD or UFD transmission will take place.

Since the CTS-FD message contains destination address of STA1, STA1 starts transmitting data at time t₃. Based on D₀ and D₁, the AP knows when the data transmission from STA1 will end, namely at time point t₄. Since STA3 is eligible to take part in the UFD transmission and the AP has data to send to STA3, the AP sends a data message to STA3 at or after time t₃.

The neighbouring STAs follow their NAV and remain quiescent after finding out that the data is intended for STA3. Therefore, a UFD transmission is successfully established by the AP. Since STA3 can be a legacy HD node, it is particularly important that the data transmission from AP to STA3 ends at time t₄. If the transmission ended before t₄ then STA3 may also send ACK before t₄, that is whilst the AP is unable to receive the ACK as it is still receives data from STA1. Therefore, the AP is configured to select a packet whose transmission time is less than or equal to t₄−(t₂+SIFS) such that the chosen MCS can deliver the packet, subject to the aforementioned time constraint. The AP is configured to select the start time of transmission (tₛ) to STA3 so that, dictated by the payload size and the MCS, data transmission ends at t₄. Let, tₑₛₜ denote the data transmission time from the AP to STA3, which is the function of payload and MCS. If tₑₛₜ=t₄−(t₂+SIFS) then tₛ=t₂+SIFS. On the other hand, if tₑₛₜ<t₄−(t₂+SIFS) then tₛ=t₄−tₑₛₜ.

It will be appreciated that the AP does not need to adjust the start time of transmission for BFD transmission. This is because STA 1 (FIG. 5) is a FD-capable node that does not automatically flag an ACK timeout if it knows that BFD transmission is taking place. Moreover, the neighbouring STAs set their waiting time in the same manner in case of BFD transmission, after hearing a CTS-FD message from the AP. The waiting time procedure is performed during the NAV duration; hence, it is completely backward compatible.

The ACK timeout setting procedure and the constraint on the AP for suitably selecting the payload and MCS are discussed with reference to the UFD transmission scenario shown in FIG. 6 and for two cases:
Case 1: Assume that the data transmission from STA 1 to AP (first transmission) finishes before the data transmission from AP to STA 3 (second transmission). In this case, the AP cannot acknowledge the transmission of STA 1 as it is already engaged in transmitting to STA 3. Therefore, STA 1 may unnecessarily re-transmit the data owing to an ACK time out.
Case 2: Assume that the data transmission from STA 1 to AP finishes after the data transmission from AP to STA 3. In this case, STA 3 cannot acknowledge the transmission of AP since the AP is engaged in receiving data from STA 1. This is because the AP (although FD capable) cannot simultaneously receive from two different STAs.

Therefore, the minimum ACK timeout for STA 1 and AP is equal to t₅, which is the sum of t₄, SIFS, and the transmission time for ACK. By setting the ACK time out to t₅, the AP does not need to unnecessarily re-transmit if the second transmission finishes before the first transmission. The AP is configured to select the payload and the MCS so that the second transmission finishes before the first transmission.

The ACK timeout setting mechanism of the embodiment (with both STA 1 and AP set the ACK timeout to t₅) is equally applicable in case of BFD transmission. The AP is configured to select the payload and the MCS such that the second transmission (from AP to STA 1) finishes before or simultaneously with the first transmission (STA 1 to AP).

The embodiments cover, amongst other scenarios, the following cases with respect to UFD transmission:
Case 1: STA 1 is HD—The proposed solution is completely applicable as the legacy STAs can read the CTS-FD control message but do not need to read the 0/1 bit.
Case 2: STA 1 is FD—The proposed solution is equally applicable as the FD STAs can read the CTS-FD control message.

In one embodiment, the AP is configured to, if more than two STAs are eligible to take part in the UFD transmission, selects the one with best channel or some other metric (to ensure fairness etc.). One way of making this selection is for the AP to maintain statistics indicating how reliably an STA had during previous data transmissions provided acknowledgement of data receipt and to preferentially select STAs indicated in thus maintained statistics as being more reliable over STA indicated in thus maintained statistics as being less reliable.

AP-Initiated Communication Scenario

The following discussion is based on the scenario shown in FIG. 4 in a situation in which that AP has data to send to STA 1.
Case 1: AP does not send an RTS and STA 1 is HD—In this case the AP directly sends a data message to STA 1. After receiving data from AP, STA 1 sends an ACK.
Case 2: AP does not send an RTS and STA 1 is FD—In this case the AP directly sends a data message to STA 1. Note that STA 1 cannot notify the AP of a potential BFD transmission in this case (through a CTS-FD as described in the STA-initiated communication scenario). Therefore, only HD transmission can take place as discussed in Case 1.
Case 3: AP sends an RTS and STA 1 is HD—In this case the legacy RTS/CTS control message exchange takes places as described with reference to FIGS. 2(a)-2(c). Other STAs set their NAV accordingly after receiving an RTS from the AP.
Case 4: AP sends an RTS and STA 1 is FD—In this case the AP sends an RTS to STA 1. Other STAs in the network hear the RTS and set their NAVs accordingly after finding out that it is destined for STA 1. If STA 1 has data to send to the AP, it responds back with a CTS-FD which notifies the AP of a BFD transmission. Therefore, the same procedure is followed for bidirectional data transmission and ACK timeout setting as described for the BFD transmission in STA-initiated scenario. This case is also illustrated in FIG. 7. If STA 1 has no data to send to the AP, it responds to the RTS with a CTS and the legacy procedure is followed as described in Case 3.

It will be appreciated that the UFD transmission scenario is not feasible in case of AP-initiated communication scenario (whether the AP sends and RTS or not).

CTS-FD Vs CTS Control Message

It is worth pointing out that the proposed protocol to enable STR mode can work with both RTS/CTS-FD handshake and legacy RTS/CTS handshake. The former is a 1-bit modification to the legacy CTS, as described earlier. However, the CTS-FD plays a critical role in mitigating the contention unfairness issue for overhearing nodes, which arises due to BFD and UFD transmissions.

As shown, STA 1 which is FD-capable is engaged in a BFD transmission with the AP. While this BFD transmission is going on, a nearby STA (STA 2) will receive erroneous/corrupted packets due to the interference arising from simultaneous reception of packets from STA 1 and AP. After the completion of BFD transmission, both AP and STA 1 will wait for DIFS duration before next contention. However, STA 2 will wait for EIFS duration before next contention, resulting in unfairness in channel access, since EIFS duration is larger than DIFS duration. In legacy 802.11 networks, EIFS is defined (for a STA to defer its channel access following the reception of corrupted packets) to allow extra time for the intended receiver (who may have received the data correctly) to return an ACK without interference. Contention unfairness issues affect both HD and FD STAs and is present in case of UFD transmission as well. To mitigate this issue FD-capable nodes are, in one embodiment, configured to, on receipt of CTS-FD control message, ignore any corrupted packets received during the NAV period.

FIG. 8 shows simulation results in a 802.11 network in an 800 m by 800 m area with a network topology with Poisson distributed STAs in a single-cell infrastructure-based scenario with path loss and Rayleigh fading. The traffic pattern is assumed to be backlogged, i.e. that there are no gaps in transmission caused by an absence of data to be sent. The transmission power of the AP and the STA have been set to 40 dBm and 30 dBm, respectively. The transmission rate is assumed to be 1 Mbps. The density of Poisson distributed STAs has been fixed to 1.5×10̂−3 (per sq·m). Further, we assumed that all STAs are FD-capable. As can be seen from this figure the gains achievable from using a combination of BFD and UFD transmission in accordance with the above described embodiment approaches a two-fold improvement with parity between UL and DL traffic.

In the following yet further embodiments will be described. To practically realise a network comprising of FD and HD capable devices, it is necessary for the communicating entities to exchange capability information. As mentioned earlier, even if the AP and some/all of STA devices are FD capable, it is essential to coordinate transmissions among the devices in the network to enable parallel simultaneous transmissions in such a way that this does not lead to interference among them.

To achieve this, the concept of different types of flags to indicate different modes of operation is introduced. The use of these flags is, again, completely backwards compatible, i.e., legacy devices ignore these fields in the packet header which are set to 0 by default. Before specific flags and the modes of operation they enable are discussed, it is worth examining how these flags could be potentially advertised so as to send appropriate signals to the entities involved in the communication. Following are several different ways in which this is achieved in embodiments. These embodiments are purely for the purpose of illustration and therefore are not meant to limit the scope of protection sought.

In one embodiment the reserved bits in the existing PLCP header is used to signal the flag. This is shown in FIG. 10. This embodiment is easy to implement and compatible with legacy nodes. Legacy nodes will set the reserved bits as all zeros (all zero is default status of reserved bits and legacy device will ignore any change on reserved bits set by other, non-legacy, STAs/APs). The rest of the nodes can map the frame status into the flags, as described below.

In another embodiment the current PLCP header is extended, as, for example, is shown in FIG. 11. The benefit of this approach is that the reserved bits remain untouched. One way of realising this is to maintaining two sets of PLCP headers—the default one for the legacy nodes and the modified one for the FD capable nodes. An FD capable node when communicating with another FD capable node uses the modified PLCP header in the embodiment. On the other hand when an FD capable node communicates with a legacy node, it uses the default (legacy) PLCP header in the embodiment. Thus, an FD capable node of the embodiment is configured to recognise both legacy PLCP header and the modified header (for enabling FD communication). Preamble and PLCP header processing may be implemented in ASICs/FPGAs to speed up header processing.

In another embodiment the flag is signalled using the reserved bits in the MAC layer header. Similar to the PLCP approach, this is easy to implement and compatible with legacy nodes. Legacy nodes will set the reserved bits as all zeros. The rest of the nodes map the frame status into the flags described later.

If the AP is a legacy device that is only capable of HD communication, then communications between STAs (HD or FD capable) and the AP follows the legacy approach. Therefore the following discussion focuses only on scenarios where the AP is FD capable. FIG. 17 shows all possible scenarios involving different types of STAs (some HD, some FD capable) which depict all the types of communications that are possible in an infrastructure setup.

There are four basic FD flags indicating four categories of frames that may exist in a FD enabled wireless network. They are FDFlag0, FDFlag1, FDFlag2, and FDFlag4. To support additional functions such as uni-directional FD, identifying hidden nodes for each node for selection during uni-directional FD, three more flags, FDFlag3, FDFlag5 and FDFlag6, are used in embodiments.
FDFlag0: When a legacy node initiates transmission to the AP this flag is “0” by default, enabling the AP to identify the STA as a legacy STA and to plan any UFD transmissions that may be desired accordingly. An example scenario depicting the use of this flag is shown in FIG. 11. As shown in this figure, when a legacy client (clientL1) sends a frame to the AP, it does not touch the flag fields in the packet header (recall that this is 0 by default). When the AP finishes receiving this frame, it will send an ACK back to the legacy client. During the course of the primary reception (frame from ClientL1), the AP is free to transmit simultaneously to any other STA (whether HD or FD) in the network as shown in the figure to exploit its full duplex capabilities by indicating FDFlag3 during the secondary transmission. During this simultaneous transmission from the AP, the clientL1 being HD capable only will not be able to hear anything as it is transmitting and cannot receive at the same time. The scenarios 4 and 5 shown in FIG. 17 are covered by the aforementioned combination of flags (i.e. FDFlag0 for the primary transmission and FDFlag3 for the secondary transmission). There are restrictions on completion time of the secondary transmission which will be elaborated next in the details pertaining to FDFlag1.
FDFlag1: This flag is used when an FD capable STA initiates transmission to the AP as shown in FIGS. 12 and 13. The presence of this flag indicates to the AP that the frame is originating from a full duplex STA. AP can then decide whether it wants to establish a bi-directional full duplex with the originating STA (clientF1 in this case, as shown in FIG. 12) or a uni-directional full duplex with some other STA, as shown in FIG. 13. If the AP decides to engage in a bidirectional full duplex with ClientF1, it will start sending a frame with FDFlag2 set. The FDFlag2 is a signal to other FD STAs in the network who may hear this frame that the AP is engaging in a bi-directional full duplex with ClientF1.
   On the other hand, if the AP decides to engage in a uni-directional full duplex, it will choose an STA to communicate to and send a frame to it with FDFlag3 set. This FDFlag3 is an indication to all other FD STAs (including the originator of the primary transmission) that the AP is engaging in a uni-directional full duplex with the STA whose MAC address appears in the destination field of this frame. Whether the AP decides to engage in a bi-directional or uni-directional FD depends on a number of factors such as fairness criteria, the channel quality to each STA (e.g. STA with better channel quality can be served with a higher MCS. Conversely, STA with a poor channel quality can be served with lower MCS but might have to be prioritised). The actual decision criteria is beyond the scope of this description. A few important points that should be noted are as follows:
      When the AP chooses to engage in a uni-directional FD communication, it selects, in one embodiment, an STA which is a hidden node of the STA from which the primary transmission originates. This is to ensure that the secondary transmission does not interfere with the primary transmission.
      The secondary transmission should end at the same time as the primary transmission ends. The time of flight of a frame is a function of the payload and MCS. The MCS to be used for each STA is known (using any standard link adaptation approach). The AP is configured to pick a payload that will result in time of flight such that the transmission of this frame completes on or before the primary transmission completes. In case of a relatively shorter transmission, to achieve the same completion time for both primary and secondary transmissions, the AP is configured to delay its secondary transmission if required.
      In the event the AP does not see the need to engage in an FD transmission (e.g. when there is no backlog of data for any STAs), the AP is configured, in one embodiment, to send a management frame such as, for example, a beacon with FDFlag2 set, that indicates to the hidden nodes of the primary transmitter that there is already a transmission in progress in the network so that the hidden nodes have the information required to supress their own transmissions until the transmission of the primary transmitter has been concluded.
      Any legacy STAs in the network simply ignore the FDFlag2 and FDFlag3 set as mentioned above. As a consequence these legacy STAs will simply perform legacy processing.
FDFlag4: FD capable AP are configured to set this flag when they initiate a transmission to an FD capable STA indicating to the STA that it can engage in a bi-directional FD communication as shown in FIG. 14. The recipient STA can start a secondary transmission in parallel to the ongoing primary transmission subject to the constraint that the secondary transmission completes at or before the same time as the primary transmission completes, in the same manner as described above with reference to the embodiment using the RTS and CTS-FD signal combination originating from either of the STA or the AP. If recipient STA does not have any data to send to the AP, it may choose to follow the legacy approach (send an ACK to the AP on completion of reception). The other FD STAs that receive the primary transmission from the AP on seeing the FDFlag4 are configured to simply go quiet until the medium is available again.
FDFlag5: FD capable APs are configured to set this flag when they initiate a transmission to an FD capable STA indicating to the STA that it will not engage in a bi-directional FD with it as shown in FIG. 15. The recipient STA simply waits for the primary transmission to complete and sends an ACK subsequently. In addition to setting the FDFLag5, the AP will also include a list of hidden nodes of the STA receiving the primary transmission in the frame. Instead of including the MAC address of each hidden STA, the AP can advertise a bitmap (example shown in Table 1) corresponding to these STAs. The AP is in one embodiment configured to assign a unique bitmap to each STA during association time (e.g. assign bitmap on receiving an association request and notify STA of its bitmap via association response frame). Further, instead of specifying each hidden STA in the frame with FDFlag5 set, the AP is, in one embodiment, configured to restrict this to a handful of hidden STAs. This enables one of these hidden STAs to initiate a transmission to the AP with FDFlag1 set. This transmission is subject to the completion time constraints as mentioned earlier, i.e. a frame for secondary transmission should be chosen such that it completes transmission at the same time as the primary transmission completes. As mentioned before, in case of a relatively shorter transmission, to achieve the same completion time for both primary and secondary transmissions, the secondary transmission at the hidden STA should be delayed if required. As before, the legacy STAs receiving frames with any type of Flag set will continue to ignore the flag field and perform legacy operation (continue to carrier sense to identify an opportunity to grab the medium).
FDFlag6: In one embodiment APs need to know the set of hidden STAs for each STA in the network for the purpose of identifying targets for invoking uni-directional FD communications. Whilst it would be desirable to have this information for both legacy as well as FD capable STAs, acquiring such information pertaining to legacy STAs may be difficult without requiring changes to the legacy terminals. As shown in FIG. 16, in one embodiment the AP advertises a frame with FDFlag6 set and indicates an order in which each STA should send an ACK (e.g. STA1, STA2, . . . , STAn). When each STA sends an ACK, every other STA makes note of the ACKs it can hear. The ACKs from other nodes that each STA can hear are the nodes within range of itself. Each STA then reports this information to the AP in the next available slot and the AP identifies the hidden nodes for each STA as the set of STAs associated with it minus the set of STAs reported by the STA in question.

TABLE 1
Unique bitmap corresponding to each STA assigned by the AP. AP will
notify each STA of its unique bitmap.

| MAC address | Bit map |
|---|---|
| STA1 | 0001 |
| STA2 | 0010 |
| STA3 | 0011 |
| STA4 | 1100 |
| . . . | . . . |

Table 2 highlights the preconditions and objectives associated with the different flags employed in the proposed method to enable FD communications. As evident from the discussion so far, both BFD and UFD can be initiated from either an FD capable AP or STA with the AP being responsible for this decision. However, in embodiments FD transmissions are constrained by the need for the secondary transmission to finish at the same time as the primary/first initiated transmission. In some cases where this may not be possible (e.g. when the secondary transmission is shorter than the primary transmission), transmissions can be staggered, for example by delaying the secondary transmission, so as to enable it to complete at the same time as the primary transmission. When referring to completion of the transmissions at the same time reference is made to completion that is simultaneous to the extent that the above mentioned subsequent acknowledgement signals can be sent and received without triggering an acknowledgement timeout.

TABLE 2
Preconditions and objectives associated with the use of the different
flags employed in the embodiment.

| FDFlag | | |
|---|---|---|
| Index | Pre-condition | Objective |
| FDFlag0 | Used by legacy AP or | Set to all zero as default in legacy device |
| | legacy STA | |
| FDFlag1 | Used by FD STA to | Allows an FD AP to recognize the FD capability of |
| | initiate a transmission to | the communication initiating STA and act |
| | an FD capable AP | accordingly |
| FDFlag2 | Could be set by FD AP in | Used by FD AP to indicate to an FD STA that it |
| | response to reception of a | intends to engage in a BFD communication. Also |
| | frame from an FD STA | meant to signal to other FD STAs to keep quite. |
| | with a FDFlag1 set. | |
| FDFlag3 | Could be set by FD AP in | Used by FD AP to indicate that it is initiating a UFD |
| | response to reception of a | communication (i.e. STAi -> AP -> STAj). |
| | frame from an HD STA | |
| | with FDFlag0 field value | |
| | of 0 or an FD STA with an | |
| | FDFlag field value of 1. | |
| FDFlag4 | Set by an FD AP to | To indicate to the FD STA that the FD AP is willing |
| | initiate a transmission to | to engage in a BFD transmission with this STA. |
| | an FD STA with the aim of | Also meant to signal to other FD STAs to Keep |
| | engaging in a BFD | quite. Recipient STA indicated in the destination |
| | transmission. | address of the primary transmission may schedule |
| | | a secondary FD transmission in parallel to AP |
| | | subject to completion constraints. |
| FDFlag5 | Set by an FD AP with the | Recipient STA indicated in the destination address |
| | aim of initiating a UFD | of the primary transmission are configured to simply |
| | | listen and ACK the transmission an completion |
| | | whereas one of the other FD STAs (one or many) |
| | | indicated in the frame are informed by this flag that |
| | | they are free to start a secondary transmission in |
| | | parallel to the FD AP. How the tie is broken in |
| | | favour of 1 out of many is implementation specific. |
| FDFlag6 | FD AP wants to collect | All the STAs that support this method will listen to |
| | hidden node information | the ongoing transmission, monitor ACKs from |
| | pertaining to STAs | different nodes and report what they can hear to the |
| | associated with it. | AP. AP will then consolidate all the information to |
| | | create the hidden node matrix. |

This ensures that legacy devices that are receiving the secondary transmission do not need to wait any longer than SIFS before they send an ACK. If the secondary transmission completes before the primary one, the legacy node might ACK immediately after waiting for SIFS and in the case where we want to the legacy terminal to wait until the primary transmission completes, a change will be required on the legacy terminal side. By enforcing that secondary transmissions to legacy devices complete at the same time as primary transmissions, full backwards compatibility with the legacy approach is ensured.

It is worth emphasising that the sequence of embodiments described above are in no particular order. The order of the flags and the way they are implemented can be changed as long as the basic function that each flag is supposed to facilitate is catered for without departing from the spirit of the invention.

It is moreover emphasised that the description of the adjustment of the acknowledgement time period in legacy STAs that is facilitated by the durations reported to the STAs from the AP provided above with reference to the embodiments using the RTS and CTS-FD message exchange also applies to the embodiments using the FDFlags.

This embodiments allow the nodes in a network that are FD capable to exploit opportunities for engaging in FD communications by, where possible, avoiding or at least minimising interference to other nodes in the network. This is achieved without requiring central control. If flags are used RTS/CTS do not have to be used. The embodiments are fully compatible with legacy nodes. The full duplex MAC protocol is realised as backwards compatible extension to the legacy protocol and is compatible with the BSS colouring method.

The first table in FIG. 18 shows the action that an STA is, in an embodiment, configured to take when it receives a packet with a specific FDFlag value if (i) the colour field in the packet matches the colour that the STA uses (ii) the colour field in the packet does not match the colour the STA uses and/or (iii) there is no colour information in the packet (this may, for example, be the case if the packet is received from a legacy node). As an example, if a packet is received with FDFlag value of 1 and colour is different, then the STA simply indicates MAC Busy.

Similarly, the 2^{nd} table in FIG. 18 shows the action an AP would take when it receives a packet with a specific FDFlag value subject to the same 3 conditions mentioned above.

FIG. 19 shows a FD AP 100 according to an embodiment. The AP comprises a transmit 110 and a receive 120 antenna or a combined antenna used for both transmission and reception, a transmit chain 130 and a receive chain 140. A self-interference cancellation mechanism 150 is provided between the transmit chain 130 and the receive chain 140 in the embodiment. The AP moreover comprises a controller 160 and non-volatile memory 170. The controller 150 is configured to access computer program instructions stored in the memory 170 and to execute the methods described herein on the basis of these instructions.

FIG. 20 shows a FD STA 200 according to an embodiment. The STA comprises a transmit 210 and a receive 220 antenna or a combined antenna used for both transmission and reception, a transmit chain 230 and a receive chain 240. A self-interference cancellation mechanism 250 is provided between the transmit chain 230 and the receive chain 240 in the embodiment. The AP moreover comprises a controller 260 and non-volatile memory 270. The controller 250 is configured to access computer program instructions stored in the memory 270 and to execute the methods described herein on the basis of these instructions.

FIG. 21 shows a method 300 performed by the controller of a FD AP on the basis of program instructions stored within memory of the AP. At step 310 the AP receives a request from an originally requesting STA that the STA wants to transmit data to the AP. At step 320 the AP checks it if has any data for sending to either the originally requesting STA or another STA with which it can enter into a communicative connection. Should this not be the case then the AP simply receives the data from the STA on step 330.

If the AP is aware of data that it wants to send then it checks in step 340 if the data is for the originally requesting STA and initiates BFD transmission in step 350 if this is the case. If the data is not to be sent to the originally requesting STA then the AP checks if the STA to which the data is to be sent is hidden from the originally requesting STA or at least partially hidden from the originally requesting STA to the extent that UFD transmission is possible. If this is not the case then the method advances to step 330. Otherwise UFD transmission is instigated in step 370.

For the BFD and the UFD transmissions that have alternatively been initiated the MCS, transmission starting point and/or (if possible following the choice of data to be sent) the data length is chosen so that the transmission from the AP to the selected STA finishes before or simultaneously with the transmission from the originally requesting STA to the AP in step 380 as described above and the thus configured data transmission then takes place in step 390.

It will be appreciated that, should it be determined that data to be sent to any particular STA is of a nature/length that does not allow the data transmission for the AP to the STA to be completed before the completion of the data transmission from the originally requesting STA to the AP then a different BFD or UFD data transmission may be made from the AP if such a different data transmission is required.

The above description relating to FIG. 21 deals with a situation in which transmission is initiated by an STA and in which the AP reacts by establishing a consequential BFD or UFD transmission. It will be appreciated that, in the alternative, the AP itself may have data to send at the outset and it contacts the relevant STA to establish a data connection for this data transmission. The STA may itself have data to be sent to the AP and may react by instigating BFD transmission with the AP, as per scenario 6 shown in FIG. 17. When other STAs receive the signal by which the AP contacts the STA to which its data is to be sent any of the other STAs that have data for sending to the AP can contact the AP advertising their desire to send such data. The AP then decides whether or not to allow the other STA to send this data, depending on transmission priorities within the network, whether or not the AP can configure its own data transmission so that it is completed before the other STA completes its data transmission to the AP and whether or not the two STAs in question are sufficiently hidden from each other to allow UFD data exchange. The two scenarios relevant for this are scenarios 7 and 8 in FIG. 17.

If an AP initiates a data transfer to an STA then all STAs in the network are informed (via the indicators discussed herein) of the fact that, at the time of the initiating of the data transfer the AP does not expect to receive data itself. The STAs in the network therefore know that, up to this point, they are free to request data transfers to the AP.

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1: A method of scheduling data transmission in a communication system comprising:
receiving at a first network node a request for data transmission to the first network node; and
scheduling a data transmission originating at first network node so that the end of the data transmission substantially coincides with or is earlier than the expected end of the data transmission to first network node, wherein
the first network node is an access point or a station.

2: A method as claimed in claim 1, further comprising determining the end of an acknowledgement timeout period for the data transmitted from the AP on the basis of the expected duration of the data received or to be received at the AP.

3: A method as claimed in claim 1, wherein scheduling a data transmission comprises determining whether or not a request for data for transmission to another network node has been generated or received at the first network node.

4: A method as claimed in claim 1, wherein scheduling a data transmission comprises scheduling a data transmission to a network node other than the network node from which the request for data transmission has been received and selecting the other network node on the basis of neighbourhood information available to the first network node so that the selected network node and the network node from which the request for data transmission has been received are partially or fully hidden from each other.

5: A method according to claim 1, further comprising transmitting data according to the scheduled data transmission and transmitting an indicator identifying that the data transmission as a BFD or UFD data transmission.

6: A method according to claim 1, wherein scheduling said data transmission comprises selecting a data size to be transmitted, a MCS for transmission of the data and/or a transmission delay so that the scheduled data transmission finished prior to or simultaneously with the requested data transmission.

7: A method as claimed in claim 5, wherein the indicator indicates that the transmission from the first network node is secondary transmission from a FD AP in a BFD transmission, a secondary transmission from a FD AP in a UFD transmission, a first transmission originating from a FD AP in a potential FD communication or that the AP wants to initiate a hidden node information collection procedure.

8: A method of capability discovery in a wireless network comprising FD capable nodes within the network advertising FD capability to other nodes by setting a flag or capability bit indicative of FD capability in a beacon, RTS control message, PLCP and/or MAC header.

9: A method as claimed in claim 8, wherein said flag or capability bit is set in a part of the beacon, RTS control message, PLCP and/or MAC header that is not accessed by network nodes that are not FD capable.

10: A device configured to execute computer program instructions, the computer program instruction such as to configure the device to schedule data transmission in a communication system comprising a FD access point and one or more STAs by:
receiving at the device a request for data transmission to the device; and
scheduling a data transmission originating the device so that the end of the data transmission substantially coincides with or is earlier than the expected end of the data transmission to device, wherein
the device is the access point or an STA of the one or more STAs.

11: A device as claimed in claim 10, further configured to determine the end of an acknowledgement timeout period for the data transmitted from the AP on the basis of the expected duration of the data received or to be received at the AP.

12: A device as claimed in claim 10, further configured so that scheduling the data transmission comprises determining whether or not a request for data for transmission to another network node has been generated or received at the device.

13: A device as claimed in claim 10, further configured so that scheduling the data transmission comprises scheduling a data transmission to a network node other than the network node from which the request for data transmission has been received and selecting the other network node on the basis of neighbourhood information available to the device so that the selected network node and the network node from which the request for data transmission has been received are partially or fully hidden from each other.

14: A device according to claim 10, further configured to transmit data according to the scheduled data transmission and to transmit an indicator identifying that the data transmission as a BFD or UFD data transmission.

15: A device according to claim 10, further configured to, as part of the scheduling of said data transmission, select a data size to be transmitted, a MCS for transmission of the data and/or a transmission delay so that the scheduled data transmission finished prior to or simultaneously with the requested data transmission.

16: A device as claimed in claim 14, wherein the indicator indicates that the transmission from the device is secondary transmission from the FD AP in a BFD transmission, a secondary transmission from the FD AP in a UFD transmission, a first transmission originating from the FD AP in a potential FD communication or that the AP wants to initiate a hidden node information collection procedure.

17: A FD capable AP configured to discover node capability in a wireless network comprising FD capable nodes by advertising FD capability to other nodes by setting a flag or capability bit indicative of FD capability in a beacon, RTS control message, PLCP and/or MAC header.

18: A FD capable AP as claimed in claim 17, wherein said flag or capability bit is set in a part of the beacon, RTS control message, PLCP and/or MAC header that is not accessed by network nodes that are not FD capable.

19: A device or FD capable AP as claimed in claim 10, based on the IEEE 802.11 standard and may comprise a semiconductor chipset or Wi-Fi consumer electronics product.

20: A FD capable AP configured to support BFD or UFD transmission in a network comprising FD and HD network nodes, the AP configured to generate different headers for indicating type and target of the transmission to the nodes in the network depending on whether the header is to be used in communication with a HD or FD node.

21: A system comprising an FD AP and HD and/or FD capable nodes, wherein the FD AP and/or one or more of the FD capable nodes is a device as claimed in claim 10.

22: A computer program product storing computer executable code configured to, when executed by a processor, cause a device comprising the processor to implement the method claimed in claim 1.
